(19) United States
(12) Patent Application Publication
(10) Pub. No.: US 2025/0108754 A1
(43) Pub. Date: Apr. 3, 2025

(54) OPEN SENSOR AND INDICATOR FOR GRAIN HOPPER TRAILER DOOR

(71) Applicant: Jay Christenson, Madelia, MN (US)

(72) Inventor: Jay Christenson, Madelia, MN (US)

(21) Appl. No.: 18/904,948

(22) Filed: Oct. 2, 2024

Related U.S. Application Data
(60) Provisional application No. 63/542,067, filed on Oct. 2, 2023.

(51) Int. Cl. B60Q 1/32; B60P 3/22

(52) U.S. Cl. CPC B60Q 1/324; B60P 3/224

(57) ABSTRACT

A system for providing visual indication of a grain hopper trailer door status. The system includes a first proximity sensor mounted to the grain hopper trailer configured to detect a position of the door of the first chute; a second proximity sensor mounted to the grain hopper trailer configured to detect a position of the door of the second chute; a light source affixed to the grain hopper trailer; and a power source. The light source is activated when the either the first proximity sensor or the second proximity sensor detects a door in an open configuration. The light source is deactivated when both the first proximity sensor and the second proximity sensor detect that both the door of the first chute and the door of the second chute are in the closed configuration.

### CROSS-REFERENCE TO RELATED APPLICATIONS

The present application claims the benefit of U.S. Provisional Application No. 63/542,067, filed on Oct. 2, 2023, the disclosure of which is incorporated by reference herein in its entirety.

### FIELD OF THE DISCLOSURE

The present invention relates to grain hopper trailers and, more specifically, to a grain hopper trailer equipped with a chute at the bottom end of the trailer that incorporates an operable door. The invention further pertains to a system for providing a visual indication of the door status.

### BACKGROUND

Grain hopper trailers are fundamental components of modern agricultural practices, facilitating the transportation of bulk grain and other granular materials from the farm to storage or distribution points. These trailers are often loaded by dumping grain into an open top. Trailers are typically parked alongside a field, where grain is harvested and loaded into the top. The trailers are designed to provide an efficient means of unloading grain by utilizing a bottom chute or discharge outlet through which the grain flows. To control the flow of grain during unloading, a door is typically installed at the lower end of the chute.

Some conventional grain hopper trailers employ manually operated chute doors. This manual operation involves considerable physical effort, time, and may result in uneven grain distribution or spillage. Certain grain hopper trailers utilize hydraulic or mechanical door actuation systems. These systems enable semi-automated or automated control of the chute door, providing advantages in terms of convenience and operational efficiency.

### SUMMARY

When hopper doors are left open, this can lead to costly spills or other accidents. This may happen for a variety of reasons. For example, the doors might be opened prior to loading in order to clear debris from the trailer or to test equipment. Doors may also be accidentally left open after unloading. Many grain hopper trailers have tracks surrounding the doors, so it is not readily visible to an operator whether a door is open or closed. Further compounding the issue, the sun sets early during harvesting seasons and trailers are loaded alongside vast agricultural fields with little to no commercial lighting, making it very difficult to determine the door position without close inspection. For automated door assemblies, most controls are very rudimentary, offering little control beyond basic functions such as “open,” “close,” or “stop.” Further, these systems offer no status indicator indicating a position of the door. The present invention addresses these needs by providing a grain hopper trailer status indicator that offers a rapid visual indication of the door position. This innovation aims to enhance the capabilities of grain hopper trailers by preventing accidental spills and loss, ultimately benefiting the agricultural industry and its stakeholders.

A system for providing visual indication of a grain hopper trailer door status in accordance with embodiments of this disclosure includes a grain hopper trailer configured for towing by a semi-truck, a first proximity sensor mounted to the grain hopper trailer, a second proximity sensor mounted to the grain hopper trailer, a light source affixed to the grain hopper trailer, and a power source connected to the first proximity sensor, the second proximity sensor, and the light source. The power source is configured to provide electrical power to the first proximity sensor, the second proximity sensor, and the light source. The grain hopper trailer has four sidewalls and a bottom. The bottom includes a first downwardly extending chute having a door configured to transition from a closed configuration to an open configuration, and a second downwardly extending chute having a door configured to transition from a closed configuration to an open configuration. The first proximity sensor is configured to detect a position of the door of the first chute and the second proximity sensor is configured to detect a position of the door of the second chute. The light source is in electrical communication with the first and second proximity sensors. The light source is activated when the either the first proximity sensor or the second proximity sensor detects a door in an open configuration. The light source is deactivated when both the first proximity sensor and the second proximity sensor detect that both the door of the first chute and the door of the second chute are in the closed configuration.

In embodiments, the light source is mounted to a sidewall of the grain hopper trailer. In embodiments, the light source is visible to a user proximate to the grain hopper trailer when the light source is activated. In embodiments, the light source is visible in a rear-view mirror mounted to the semi-truck to a user seated in the semi-truck when the light source is activated. In embodiments, the proximity sensor is an infrared, ultrasonic, magnetic, or capacitive sensor. In embodiments, the light source is a Light Emitting Diode (LED). In embodiments, the power source is a rechargeable battery. In embodiments, the power source comprises a solar panel. In embodiments, the power source is the semi-truck.

According to an embodiment of the invention, a sensor assembly affixed to a grain hopper trailer includes a first proximity sensor unit, a first light source, and a power source. The first proximity sensor unit is configured to detect the position of a first door on the grain hopper trailer. The first light source is affixed to the grain hopper trailer. The power source is connected to the first sensor unit and the first light source. The power source is further configured to provide electrical power for the operation of the first proximity sensor unit and the first light source. The first light source receives a signal from the first proximity sensor unit indicating a position of the door.

In embodiments, the first light source is illuminated when the signal from the first proximity sensor unit indicates that the first door is open, and the light source is deactivated when the signal from the first proximity sensor unit indicates that the first door is closed. In embodiments, the first light source is illuminated with a first color when the signal from the first proximity sensor unit indicates that the first door is open, and the first light source is illuminated with a second color when the signal from the first proximity sensor unit indicates that the first door is closed.

In embodiments, the sensor assembly further includes a second sensor unit configured to detect the position of a second door on the grain hopper trailer. The second sensor unit is connected to the power source and the first light source such that the first light source is illuminated when the first or second door is open, and the first light source is deactivated when both the first and second doors are closed.

In embodiments, the sensor assembly further includes a second sensor unit configured to detect the position of a second door on the grain hopper trailer. The second sensor unit is connected to the power source and the first light source such that the first light source is illuminated a first color when the first or second door is open, and the first light source is illuminated a second color when both the first and second doors are closed.

In embodiments, the sensor assembly further includes a second sensor unit configured to detect the position of a second door on the grain hopper trailer. The second sensor unit is connected to the power source and the first light source such that the first light source is illuminated a first color when only the first door is open, a second color when only the second door is open, a third color when both the first and second doors are open, and the light source is illuminated a fourth color when both the first and second doors are closed.

In embodiments, the sensor assembly further includes a second sensor unit configured to detect the position of a second door on the grain hopper trailer. The second sensor unit is connected to the power source and a second light source such that the second light source is illuminated when the second door is open, and the second light source is deactivated when the second door is closed. In embodiments, the second light source is a different color than the first light source.

In embodiments, the first light source has a variable brightness. In embodiments, the variable brightness is automatically adjusted in relation to ambient light. In embodiments, the sensor assembly further includes a wireless control module in electrical communication with the first proximity sensor unit. The wireless control module may be configured to wirelessly transmit the door status to a remote indicator.

A feature and advantage of embodiments of the disclosure is the door status is readily determined by a user proximate the trailer. A feature and advantage of embodiments of the disclosure is the door status is readily determined in the dark. A feature and advantage of embodiments of the disclosure is the door status is readily determined by a driver sitting inside the semi-truck. A feature and advantage of embodiments of the disclosure is the door status is readily determined by a user approaching the trailer, such as an operator transporting a load of grain to deposit in the hopper trailer. A feature and advantage of embodiments of the disclosure is the sensor assembly is readily operable with conventional grain hopper trailers already in use.

### BRIEF DESCRIPTION OF THE DRAWINGS

The present invention will become more fully understood from the detailed description given herein below for illustration only, and thus not limitative of the present invention, wherein:

FIG. 1A is a perspective view of a semi-truck with a grain hopper trailer and sensor assembly in accord with embodiments;

FIG. 1B is a perspective view of the semi-truck and trailer of FIG. 1B with a hopper door in the open position and the indicator light illuminated in accord with embodiments;

FIG. 2A is a top view of an empty trailer with one hopper door in a partially open configuration and the indicator light illuminated in accord with embodiments;

FIG. 2B is an enlarged perspective view of a grain hopper trailer with a chute and a door in the closed position in accord with embodiments;

FIG. 2C is a perspective view of the chute of FIG. 2B with the door in the open position and the indicator light illuminated in accord with embodiments;

FIG. 3 is a perspective view of a rear view mirror of a semi-truck showing a grain hopper trailer with an illuminated indicator light in accord with embodiments of the invention;

FIG. 4 is a remote device indicating a status of a chute door on a grain hopper trailer in accord with embodiments of the invention;

FIG. 5A is a schematic diagram of the electrical connections of a sensor assembly having one sensor and one light source in accord with embodiments;

FIG. 5B is a schematic diagram of the electrical connections of FIG. 5A with a second sensor;

FIG. 5C is a schematic diagram of the electrical connections of FIG. 5A with a controller; and

While embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

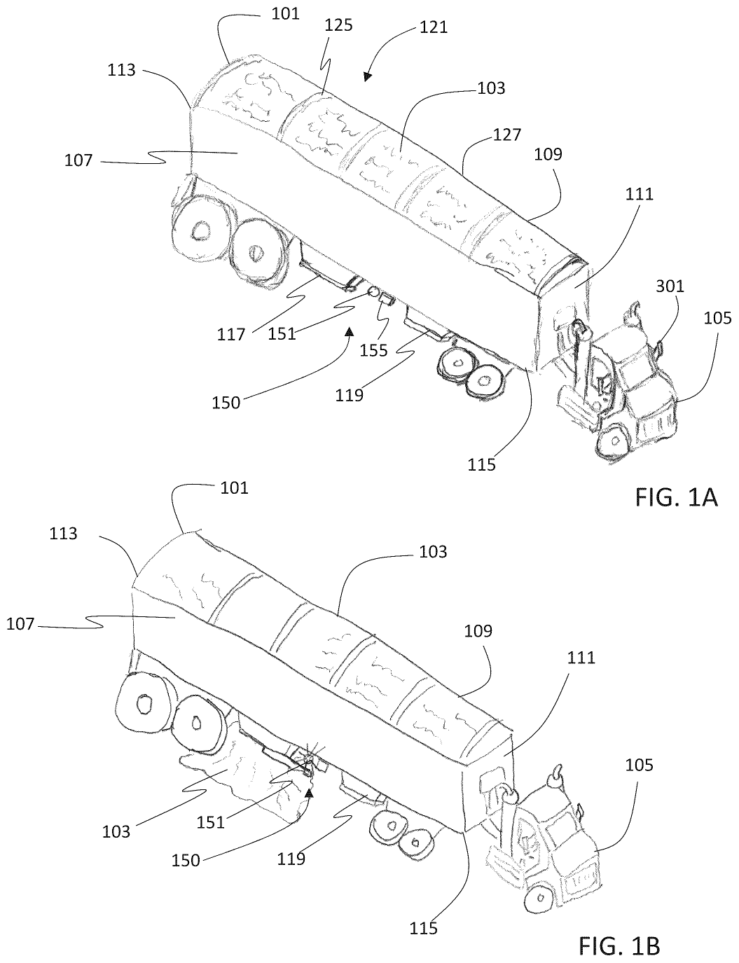

Referring to FIGS. 1-3, a grain hopper trailer 101 is shown loaded with grain 103 and secured to a semi-truck 105 in a hauling configuration. The grain hopper trailer has opposing left and right sidewalls 107, 109, front sidewall 111, rear sidewall 113, and a bottom 115, defining a generally open interior 116 that may retain material for hauling. As shown, the grain hopper trailer 101 has a first chute 117 and a second chute 119 extending downwardly from the trailer bottom 115. In some embodiments, a trailer may have more or fewer chutes. In some embodiments, a trailer may have a single chute. In some embodiments, a trailer may have three, four, or more chutes. In some embodiments, chutes are generally spaced equidistant along the bottom of the trailer between the front and rear trailer sidewalls. For example, a trailer with a single chute may have the chute generally centered in the trailer bottom. In another example, a trailer with two chutes may have a first chute at roughly one-third of the distance between the front and rear sidewalls, and a second chute at roughly two-thirds of the distance between the front and rear sidewalls. In some embodiments, the bottom 115 of the trailer 101 can be generally sloped or tapered towards the one or more chutes 117, 119. In some embodiments, one or more of the sidewalls 107, 109, 111, 113 may be sloped or tapered towards the one or more chutes.

In some embodiments, the trailer 101 may have an open top 121 to facilitate loading of material. For example, the trailer 101 may be filled with a granular material 103, such as grain. Granular material 103 may be loaded, for example, with a bucket loader, a conveyor belt, a chute, or other known agricultural equipment. Accordingly, a grain hopper trailer 101 may be pulled by the semi-truck 105 to a farm or field, often in remote locations, where the grain is loaded. The grain is then hauled to a from the farm or field to an unloading facility, where the grain is discharged through the one or more chutes in the bottom of the trailer, for storage, processing, and/or distribution. In some embodiments, a trailer 101 may have one or more struts or bows 125 extending between top edges 127 of the sidewalls 107, 109, 111, 113 to support a tarp, canopy, or the like (not shown) that can be used to cover the trailer top 121 during transport.

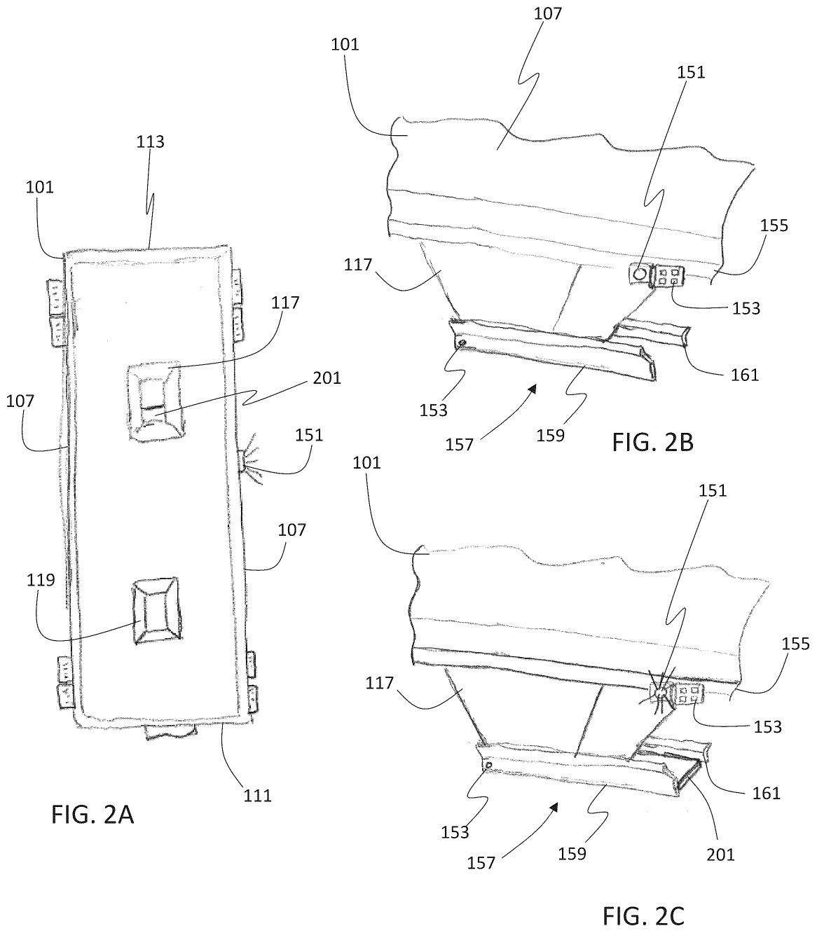

Referring specifically to FIG. 2, a top view of an empty grain trailer 101 is shown with a first chute 117 and a second chute 119. The first chute 117 is tapered towards a first door 201 and second chute 119 is tapered towards a second door 203. As shown, the first door 201 is in a partially open configuration and the second door 203 is in a closed configuration. As discussed above, granular material 123 is loaded into the open top of the trailer 101. The slope of the chutes 117 and 119, along with any additional slope of the trailer sidewalls and/or bottom, facilitate the movement of the granular material towards the doors 201, 203. Accordingly, it is critical that the doors 201, 203 are closed during loading and transport. Referring specifically to FIG. 1B, a trailer 101 is shown with a first open rear door 201 and granular material 123 exiting the bottom of chute 117.

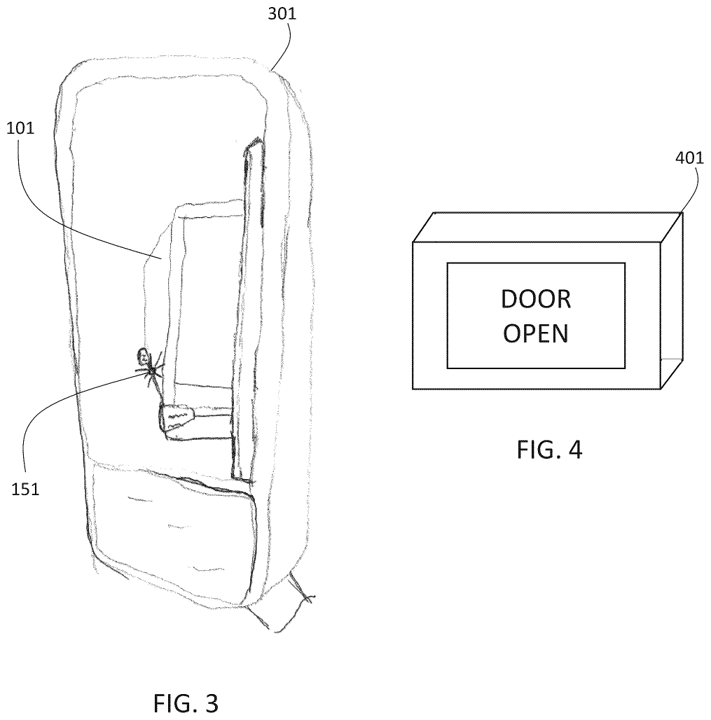

FIGS. 1-3 depict a sensor assembly 150 mounted to the grain hopper trailer 101. The sensor assembly includes an indicator light 151 and a sensor unit 153. The indicator light 151 may be affixed to the trailer 101 at or near a sidewall 107, 109, or other location where it is readily visible when illuminated. In some embodiments, the indicator light 151 may include a mountable housing 153. In embodiments, the mountable housing 153 may be affixed to a bracket in connection with chute door controls 155. In embodiments, indicator light 151 may be a conventional bulb. In embodiments, indicator light 151 may be an LED. In embodiments, indicator light 151 may be configured to display different colors as determined by an input signal. In embodiments, indicator light 151 may be configured to display a pattern, such as flashing on and off at predetermined patterns based on an input signal. In embodiments, more than one indicator light 151 may be mounted on the trailer 101. For example, a first indicator light 151 may be mounted on the left sidewall 107 and a second indicator light 151 may be mounted on the right sidewall 109. Accordingly, an operator would be able to see an illuminated indicator light 151 regardless of their position with respect to trailer 101. Referring specifically to FIG. 3, an image of trailer 101 is shown in a rear-view mirror 301 attached to the semi-truck. As shown, an operator seated in the cab of the semi-truck can readily see if the indicator light 151 is illuminated merely by checking a rear-view mirror 301, without having to exit the cab. Referring to FIG. 4, a door status indicator may be displayed on a remote device 401. The remote device 401 may be a handheld device, a screen such as an LCD screen, or an indicator light. In embodiments, the remote device 401 may be located within the cab. In embodiments, the remote device 401 may be transportable by an operator.

The sensor unit 153 is configured to determine a position of a chute door. In embodiments, the sensor unit 153 may be a proximity sensor. Referring to FIG. 2B, an enlarged partial perspective view of a trailer 101 and chute 117 are shown. The indicator light 151 and chute door controls 153 are mounted near a bottom edge 155 of the trailer 101. In embodiments, a door assembly 157 may be mounted near the bottom of chute 117. The door assembly may include a pair of opposing rails 159, 161. The hopper door 201 may be slidingly mounted within the rails 159, 161. In embodiments, the door 201 may be manually, mechanically, electrically, or hydraulically actuated. Examples of grain hopper trailers, door assemblies, and openers may be found, for example, in U.S. Pat. Nos. 8,319,660; 8,371,657; 9,568,064; and 10,059,245, the contents of which are herein incorporated by reference in their entireties for all purposes.

The sensor unit 153 is shown mounted at an end portion of rail 159, such that the sensor unit 153 may detect if door 201 is open or partially open. As shown in FIG. 2B, when the door 201 is partially open, the indicator light 151 is illuminated. Different sensor unit locations are not beyond the scope of this disclosure. For example, the sensor unit 153 could be mounted at an end of the chute 117 between rails 159, 161. Alternatively, the sensor unit 153 could be mounted at an opposite end of rail 159 such that the sensor unit detects when the door 201 is in the fully open position as opposed to detecting a closed position. Further, regardless of whether the sensor unit itself detects the open or closed position; the indicator light may be configured accordingly to display the desired status. For example, if the sensor unit is positioned such that it sends a signal when the door is in the closed position, the indicator light can be configured to illuminate when there is no signal present, thereby indicating the door is open. It should also be appreciated that any type of sensor that may determine a position of the door is not beyond the scope of the disclosure. In embodiments, the sensor unit may be an infrared, ultrasonic, magnetic, or capacitive sensor.

In embodiments, additional mounting brackets may be included or provided as a kit such that components may be mounted on grain hoppers from various manufacturers. For example, a kit may include a sensor, a light, and a pack of mounting brackets suitable for attaching the components to various grain hopper trailers. In embodiments, a kit may further include a power supply. In embodiments, a kit may include a set of written instructions. Such instructions may include, for example, instructions on mounting and/or wiring the various kit components.

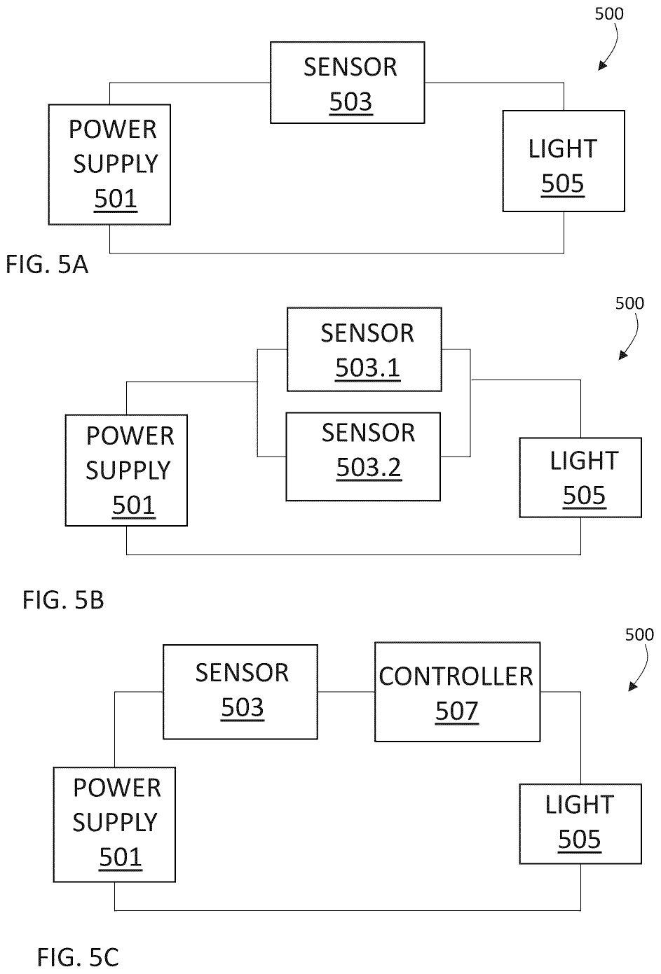

FIGS. 5A-5C depict schematic diagrams of embodiments of a sensor assembly 500. Referring to FIG. 5A, a sensor assembly may include a power source 501, a sensor 503, and a light 505. In embodiments, the power source 501 may be a battery pack. For example, a battery pack may be a power bank with commercially available batteries such as AA, C, D, or the like. In embodiments, the power source 501 may be a rechargeable power bank such as a solar panel or photovoltaic cell. As shown, the sensor 503 may act as a switch sending a signal to light 505. Accordingly, when the sensor 503 is activated, it sends a signal causing the light 505 to illuminate. Conversely, when the sensor 503 is not activated, the lack of signal causes the light 505 to deactivate. In embodiments, the power source 501 may be hard wired into the other electrical systems in the trailer 101 and/or semi-truck 105.

Referring to FIG. 5B, a sensor assembly may include a power source 501, a first sensor 503.1, a second sensor 503.2, and a light 505. As shown, the first and second sensors 503.1, 503.2 are connected in parallel. Accordingly, if either sensor 503.1, 503.2 is activated, the signal will pass through to the light 505 causing it to illuminate. As such, a single assembly 500 may monitor two hopper doors using a single power source and a single light. It should be recognized that the status of additional hopper doors may be monitored simply by adding additional sensors 503 in parallel with other sensors already in the assembly. For example, five hopper doors could be monitored by wiring five sensors in parallel. Alternatively, the assembly shown in FIG. 5A could be duplicated for each door, such that multiple lights are mounted to the trailer. In such embodiments, the spatial relation of the multiple lights could be associated with particular hopper doors. However, associating lights or indicators with particular hopper doors can be accomplished with other means as well. For example, the light associated with the first hopper door could be red and the light associated with a second hopper could be blue.

Referring to FIG. 5C, the signal from sensor 503 may be passed to a controller 507. In such an embodiment, multiple sensors may pass signals to the controller 507 allowing for a variety of visual indicators that indicate various statuses. For example, the light 505 may be an LED having variable colors. Accordingly, the controller 507 could change the color of the light 505 if one hopper door is open as opposed to more than one hopper door is open. Similarly, the color may indicate which hopper door is open. For example, a light color associated with the first hopper door could be yellow, a light color with a second hopper could be blue, and a light color for a third door could be red. Alternatively, a pulsing or flashing light may be used to determine a status. For example, the controller may pulse or flash the light if a single door is open, or maintain a solid, continuous illumination if both doors are open. In embodiments, the controller 507 may include additional modules. For example, the controller 507 may include a wireless transceiver configured to transmit a door status to a light mounted elsewhere, such as in the semi-truck cab, or to a handheld device 401.

The embodiments above are intended to be illustrative and not limiting. Additional embodiments are within the claims. In addition, although the present disclosure has been described with reference to particular embodiments, those skilled in the art will recognize that changes can be made in form and detail without departing from the spirit and scope of the disclosure. Any incorporation by reference of documents above is limited such that no subject matter is incorporated that is contrary to the explicit disclosure herein. To the extent that specific structures, compositions and/or processes are described herein with components, elements, ingredients or other partitions, it is to be understood that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated. The use of the term “about” herein refers to expected uncertainties in the associated values as would be understood in the particular context by a person of ordinary skill in the art.

What is claimed is:

1. A system for providing visual indication of a grain hopper trailer door status, the system comprising:
a grain hopper trailer configured for towing by a semi-truck, the grain hopper trailer having four sidewalls and a bottom, the bottom comprising a first downwardly extending chute having a door configured to transition from a closed configuration to an open configuration, and a second downwardly extending chute having a door configured to transition from a closed configuration to an open configuration;
a first proximity sensor mounted to the grain hopper trailer configured to detect a position of the door of the first chute;
a second proximity sensor mounted to the grain hopper trailer configured to detect a position of the door of the second chute;
a light source affixed to the grain hopper trailer, the light source in electrical communication with the first and second proximity sensors; and
a power source connected to the first proximity sensor, the second proximity sensor, and the light source, the power source configured to provide electrical power to the first proximity sensor, the second proximity sensor, and the light source,
wherein the light source is activated when the either the first proximity sensor or the second proximity sensor detects a door in an open configuration, and
wherein the light source is deactivated when both the first proximity sensor and the second proximity sensor detect that both the door of the first chute and the door of the second chute are in the closed configuration.

2. The system of claim 1, wherein the light source is mounted to a sidewall of the grain hopper trailer.

3. The system of claim 1, wherein the light source is visible to a user proximate to the grain hopper trailer when the light source is activated.

4. The system of claim 1, wherein the light source is visible in a rear-view mirror mounted to the semi-truck to a user seated inside the semi-truck when the light source is activated.

5. The system of claim 1, wherein the proximity sensor is an infrared, ultrasonic, magnetic, or capacitive sensor.

6. The system of claim 1, wherein the light source is a Light Emitting Diode (LED).

7. The system of claim 1, wherein the power source is a rechargeable battery.

8. The system of claim 1, wherein the power source comprises a solar panel.

9. The system of claim 1, wherein the power source is the semi-truck.

10. A sensor assembly affixed to a grain hopper trailer, the sensor assembly comprising:
a first proximity sensor unit configured to detect the position of a first door on the grain hopper trailer;
a first light source affixed to the grain hopper trailer; and
a power source connected to the first sensor unit and the first light source, the power source configured to provide electrical power for the operation of the first proximity sensor unit and the first light source,
wherein the first light source receives a signal from the first proximity sensor unit indicating a position of the door.

11. The sensor assembly of claim 10, wherein the first light source is illuminated when the signal from the first proximity sensor unit indicates that the first door is open, and the light source is deactivated when the signal from the first proximity sensor unit indicates that the first door is closed.

12. The sensor assembly of claim 10, wherein the first light source is illuminated with a first color when the signal from the first proximity sensor unit indicates that the first door is open, and the first light source is illuminated with a second color when the signal from the first proximity sensor unit indicates that the first door is closed.

13. The sensor assembly of claim 10, further comprising a second sensor unit configured to detect the position of a second door on the grain hopper trailer, the second sensor unit connected to the power source and the first light source, wherein the first light source is illuminated when the first or second door is open, and the first light source is deactivated when both the first and second doors are closed.

14. The sensor assembly of claim 10, further comprising a second sensor unit configured to detect the position of a second door on the grain hopper trailer, the second sensor unit connected to the power source and the first light source, wherein the first light source is illuminated a first color when the first or second door is open, and the first light source is illuminated a second color when both the first and second doors are closed.

15. The sensor assembly of claim 10, further comprising a second sensor unit configured to detect the position of a second door on the grain hopper trailer, the second sensor unit connected to the power source and the first light source, wherein the first light source is illuminated a first color when only the first door is open, a second color when only the second door is open, a third color when both the first and second doors are open, a fourth color when both the first and second doors are closed.

16. The sensor assembly of claim 10, further comprising a second sensor unit configured to detect the position of a second door on the grain hopper trailer, the second sensor unit connected to the power source and a second light source, wherein the second light source is illuminated when the second door is open, and the second light source is deactivated when the second door is closed.

17. The sensor assembly of claim 16, wherein the second light source is a different color than the first light source.

18. The sensor assembly of claim 10, wherein the first light source has a variable brightness.

19. The sensor assembly of claim 18, wherein the variable brightness automatically adjusts in relation to ambient light.

20. The sensor assembly of claim 10, further comprising a wireless control module in electrical communication with the first proximity sensor unit, the wireless control module configured to wirelessly transmit a door status to a remote indicator.
